(19) United States
(12) Patent Application Publication
(10) Pub. No.: US 2025/0129243 A1
(43) Pub. Date: Apr. 24, 2025

(54) RESIN COMPOSITION, AND CURABLE FILM AND LAMINATED PLATE CONTAINING SAME

(71) Applicant: Mitsubishi Gas Chemical Company, Inc, Tokyo (JP)

(72) Inventors: Kouta ITO, Yokkaichi-shi, Mie (JP); Takayuki IIJIMA, Yokkaichi-shi, Mie (JP); Makoto MIYAMOTO, Katsushika-ku, Tokyo (JP)

(21) Appl. No.: 18/293,946

(22) PCT Filed: Aug. 23, 2022
(86) PCT No.: PCT/JP2022/031688

§ 371 Date: Jan. 31, 2024

(30) Foreign Application Priority Data
Aug. 27, 2021 (JP) 2021-138646

(51) Int. Cl. C08L 51/08; C08F 290/06; C08J 5/04; C08K 5/3415; C23C 22/02

(52) U.S. Cl. CPC C08L 51/08; C08F 290/062; C08J 5/043; C08K 5/3415; C23C 22/02; C08J 2351/08; C08L 2203/16

(57) ABSTRACT

According to the present invention, there can be provided a resin composition comprising a phenylene ether resin and a petroleum resin, wherein the phenylene ether resin is represented by the following general formula (1):

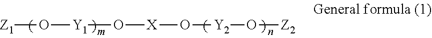

wherein X represents a unit comprising an aromatic ring; Y₁ and Y₂, which may be the same or different, each represent a phenylene group; Z₁ and Z₂, which may be the same or different, each represent a hydrogen atom or a unit comprising a polymerizable double bonding group; and at least any one of m and n is not 0, and m and n represent an integer of 0 to 300, wherein
in the general formula (1), with regard to the percentage (%) of the number of the polymerizable double bonding groups (A) [eq./g] and the number of hydroxyl groups (B) [eq./g], (A)/(B)=95.0 to 99.5/0.5 to 5.0.

### TECHNICAL FIELD

The present invention relates to a resin composition comprising a phenylene ether resin and a petroleum resin, and further, relates to a curable film and a laminated plate, each comprising the resin composition.

### BACKGROUND ART

Phenylene ether resin is used mainly in the electronics field in which low dielectric constant, low dielectric dissipation factor and high toughness are required, and is also used for a large variety of intended uses such as coating, adhesion, and molding (Patent Literature 1). However, since the phenylene ether resin has high melt viscosity, there is still room for improvement in moldability. In addition, when the phenylene ether resin is used in laminated plates, It is problematic in that its adhesiveness to copper and glass cloth is weak and its peel strength is low.

### CITATION LIST

### Patent Literature

Patent Literature 1: Japanese Patent No. 3879831

### SUMMARY OF INVENTION

### Technical Problem

It is an object of the present invention to provide a resin composition exhibiting an excellent dielectric property (low dielectric dissipation factor) and having a reduced melt viscosity. Further, it is another object of the present invention to provide a resin composition exhibiting an excellent dielectric property (low dielectric dissipation factor), having a reduced melt viscosity, and having an increased peel strength.

### Solution to Problem

As a result of intensive studies directed towards solving prior art problems, the present inventors have found that a resin composition exhibiting an excellent dielectric property (low dielectric dissipation factor) and having a reduced melt viscosity can be obtained by adding a petroleum resin to a specific phenylene ether resin, thereby completing the present invention.

Furthermore, the present inventors have also found that a resin composition exhibiting an excellent dielectric property (low dielectric dissipation factor), having a reduced melt viscosity, and having an increased peel strength can be obtained by adding a petroleum resin and a thermoplastic elastomer to a specific phenylene ether resin, thereby completing the present invention.

Specifically, the present invention includes the following aspects. <1> A resin composition comprising a phenylene ether resin and a petroleum resin, wherein the phenylene ether resin is represented by the following general formula (1):

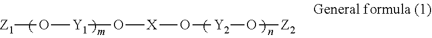

wherein X represents a unit comprising an aromatic ring; Y₁ and Y₂, which may be the same or different, each represent a phenylene group; Z₁ and Z₂, which may be the same or different, each represent a hydrogen atom or a unit comprising a polymerizable double bonding group; and
at least any one of m and n is not 0, and m and n represent an integer of 0 to 300, wherein
in the general formula (1), with regard to the percentage (%) of the number of the polymerizable double bonding groups (A) [eq./g] and the number of hydroxyl groups (B) [eq./g], (A)/(B)=95.0 to 99.5/0.5 to 5.0.
   <2> The resin composition according to the above <1>, wherein the phenylene ether resin represented by the general formula (1) is a resin represented by the following general formula (2):

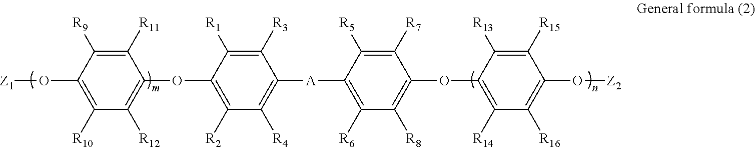

wherein A represents a single bond, or a linear, branched or cyclic hydrocarbon containing 10 or less carbon atoms; R₁ to R₁₆, which may be the same or different, each represent a hydrogen atom, a halogen atom, a linear or branched alkyl group containing 6 or less carbon atoms, or a phenyl group; at least any one of m and n is not 0, and m and n represent an integer of 0 to 300; and Z₁ and Z₂, which may be the same or different, each represent a hydrogen atom, or a substituent represented by the following general formula (3) or the following general formula (4):

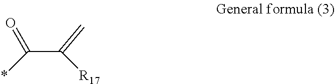

wherein R₁₇ represents a hydrogen atom or a methyl group; and * represents an atomic bonding.

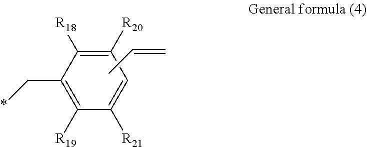

wherein R₁₈ to R₂₁, which may be the same or different, each represent a hydrogen atom, a halogen atom, a linear or branched alkyl group containing 6 or less carbon atoms, or a phenyl group; and * represents an atomic bonding.
   <3> The resin composition according to the above <2>, wherein the resin represented by the general formula (2) is a resin represented by the following general formula (5):

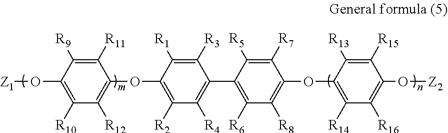

wherein R₁ to R₁₆, which may be the same or different, each represent a hydrogen atom, a halogen atom, a linear or branched alkyl group containing 6 or less carbon atoms, or a phenyl group; at least any one of m and n is not 0, and m and n represent an integer of 0 to 300; and Z₁ and Z₂, which may be the same or different, each represent a hydrogen atom, or the substituent represented by the general formula (3) or the general formula (4).
   <4> The resin composition according to the above <3>, wherein, in the general formula (5), R₁, R₂, R₃, R₆, R₇, R₈, R₉, R₁₀, R₁₅, and R₁₆ each represent a methyl group, and R₄, R₅, R₁₁, R₁₂, R₁₃, and R₁₄ each represent a hydrogen atom.
   <5> The resin composition according to any one of the above <1> to <4>, wherein the number average molecular weight (Mn) of the phenylene ether resin represented by the general formula (1) is 800 to 3000, and the weight average molecular weight (Mw) thereof is 800 to 6000.
   <6> The resin composition according to any one of the above <1> to <5>, wherein, with regard to the mass ratio between the phenylene ether resin and the petroleum resin, the phenylene ether resin/the petroleum resin=90/10 to 50/50.
   <7> The resin composition according to any one of the above <1> to <6>, wherein the softening point of the petroleum resin is 80° C. or higher.
   <8> The resin composition according to any one of the above <1> to <7>, which further comprises a crosslinking agent.
   <9> The resin composition according to the above <8>, wherein the crosslinking agent is bismaleimide.
   <10> The resin composition according to the above <8> or <9>, wherein, with regard to the mass ratio among the phenylene ether resin, the petroleum resin and the crosslinking agent, the phenylene ether resin/(the petroleum resin+ the crosslinking agent)=90/10 to 30/70.
   <11> The resin composition according to any one of the above <1> to <10>, which further comprises a thermoplastic elastomer.
   <12> The resin composition according to the above <11>, wherein the thermoplastic elastomer is a styrene-based thermoplastic elastomer.
   <13> The resin composition according to the above <12>, wherein the styrene-based thermoplastic elastomer comprises 10% to 50% by mass of a polystyrene site.
   <14> The resin composition according to the above <11> or <12>, wherein, with regard to the mass ratio among the phenylene ether resin, the petroleum resin, the crosslinking agent and the thermoplastic elastomer, the phenylene ether resin/(the petroleum resin+the crosslinking agent+the thermoplastic elastomer)=90/10 to 30/70.
   <15> A curable film comprising the resin composition according to any one of the above <1> to <14>.
   <16> A laminated plate comprising the resin composition according to any one of the above <1> to <14>.

### Advantageous Effects of Invention

According to one embodiment of the present invention, there can be provided a resin composition exhibiting an excellent dielectric property (low dielectric dissipation factor) and having a reduced melt viscosity. Further, according to another embodiment of the present invention, there can be provided a resin composition exhibiting an excellent dielectric property (low dielectric dissipation factor), having a reduced melt viscosity, and having an increased peel strength.

### DESCRIPTION OF EMBODIMENTS

Hereafter, the present invention will be described in detail, while exemplifying synthetic examples, example, etc. However, the present invention is not limited to the exemplified synthetic examples, example, etc., and the present invention can also be carried out by altering the methods to any given methods, unless they are greatly deviated from the contents of the present invention.

### First Embodiment

A first embodiment of the present invention is a resin composition comprising a phenylene ether resin and a petroleum resin. According to the first embodiment of the present invention, there can be provided a resin composition exhibiting an excellent dielectric property (low dielectric dissipation factor) and having a reduced melt viscosity.

With regard to the mass ratio between the phenylene ether resin and the petroleum resin in the resin composition of the first embodiment, it is preferably the phenylene ether resin/the petroleum resin=90/10 to 50/50, and more preferably 90/10 to 70/30. When the amount of the petroleum resin is less than 10% by mass, the effect of reducing melt viscosity may decrease. On the other hand, when the amount of the petroleum resin exceeds 50% by mass, the glass transition point (Tg) may become too low.

The dielectric dissipation factor (Df) at 10 GHz of a cured product of the resin composition of the first embodiment is preferably 0.0040 or less, and more preferably 0.0025 or less.

The glass transition point (Tg) of a cured product of the resin composition of the first embodiment is preferably high from the viewpoint of heat resistance. It is preferably 180° C. or higher, and more preferably 200° C. or higher.

The resin composition of the first embodiment preferably has a minimum melt viscosity that is at least 30% lower than the resin composition comprising the same components except that it does not comprise a petroleum resin, and more preferably has a minimum melt viscosity that is 40% to 70% lower than the resin composition comprising the same components except that it does not comprise a petroleum resin.

Besides, as methods of measuring the dielectric dissipation factor, the glass transition point, and the melt viscosity, the methods described in the Examples as mentioned later can be adopted.

<Phenylene ether resin> The phenylene ether resin used in the present invention is represented by a general formula (1) shown below, and with regard to the percentage (%) of the number of polymerizable double bonding groups (A) [eq./g] and the number of hydroxyl groups (B) [eq./g] in the general formula (1), (A)/(B)=95.0 to 99.5(%)/0.5 to 5.0(%).

The present inventors have found that both an excellent dielectric property (low dielectric dissipation factor) and a reduction in the melt viscosity can be achieved by setting (A)/(B) to be within the above-described range. The number of hydroxyl groups (B) means the number of hydroxyl groups (—OH) possessed by the phenylene ether resin at the termini thereof. As the number of hydroxyl groups increases, the percentage of polymerizable groups relatively decreases, and thus, the melt viscosity is reduced with the presence of uncured sites. However, if the percentage of the number of hydroxyl groups (B) is higher than 5.0(o), the dielectric dissipation factor unfavorably increases due to the influence of polar groups. On the other hand, if the percentage of the number of hydroxyl groups (B) is less than 0.5(%), the melt viscosity unfavorably increases due to an increase in the relative amount of the cured product. The percentage of (A)/(B) is preferably 96.0 to 99.5(%)/0.5 to 4.0(%), and more preferably 96.7 to 99.0(%)/1.0 to 3.3(%).

Besides, the number of hydroxyl groups (B) can be measured by the method described in the Examples as mentioned later.

Hereafter, the phenylene ether resin represented by the following general formula (1) will be described.

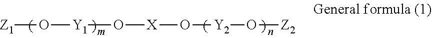

In the general formula (1), X represents a unit comprising an aromatic ring; Y₁ and Y₂, which may be the same or different, each represent a phenylene group; and Z₁ and Z₂, which may be the same or different, each represent a hydrogen atom or a unit comprising a polymerizable double bonding group. At least any one of m and n is not 0, and m and n represent an integer of 0 to 300, and preferably an integer of 1 to 50.

The phenylene ether resin represented by the above general formula (1) is preferably a resin represented by the following general formula (2).

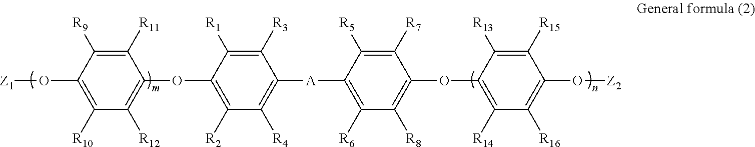

In the general formula (2), A represents a single bond, or a linear, branched or cyclic hydrocarbon containing 10 or less carbon atoms (preferably, 1 to 6 carbon atoms). R₁ to R₁₆, which may be the same or different, each represent a hydrogen atom, a halogen atom, a linear or branched alkyl group containing 6 or less carbon atoms (preferably, 1 to 4 carbon atoms), or a phenyl group. At least any one of m and n is not 0, and m and n represent an integer of 0 to 300, and preferably represent an integer of 1 to 50. Z₁ and Z₂, which may be the same or different, each represent a hydrogen atom, or a substituent represented by the following general formula (3) or the following general formula (4).

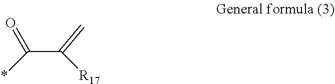

In the general formula (3), R₁₇ represents a hydrogen atom or a methyl group. * represents an atomic bonding.

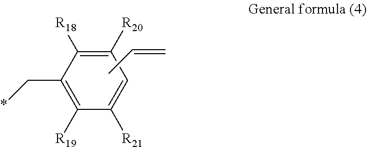

In the general formula (4), R₁₈ to R₂₁, which may be the same or different, each represent a hydrogen atom, a halogen atom, a linear or branched alkyl group containing 6 or less carbon atoms (preferably, 1 to 4 carbon atoms), or a phenyl group. * represents an atomic bonding.

The resin represented by the above general formula (2) is preferably a resin represented by the following general formula (5).

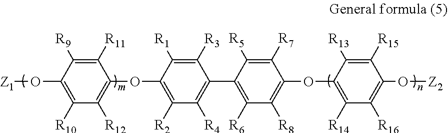

In the general formula (5), R₁ to R₁₆, which may be the same or different, each represent a hydrogen atom, a halogen atom, a linear or branched alkyl group containing 6 or less carbon atoms (preferably, 1 to 4 carbon atoms), or a phenyl group. At least any one of m and n is not 0, and m and n represent an integer of 0 to 300, and preferably represent an integer of 1 to 50. Z₁ and Z₂, which may be the same or different, each represent a hydrogen atom, or the substituent represented by the above general formula (3) or the above general formula (4).

In the above general formula (5), it is preferable that R₁, R₂, R₃, R₆, R₇, R₈, R₉, R₁₀, R₁₅, and R₁₆ each represent a methyl group, and that R₄, R₅, R₁₁, R₁₂, R₁₃, and R₁₄ each represent a hydrogen atom.

Specific examples of the phenylene ether resin represented by the above general formula (1) may particularly preferably include resins represented by the following structural formulae.

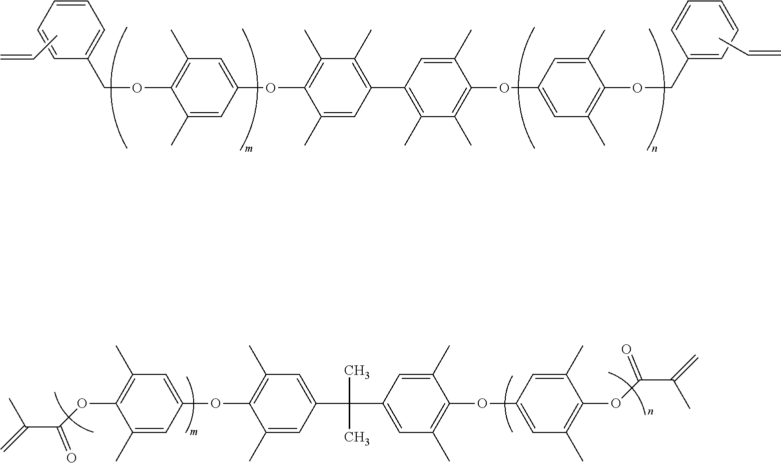

The phenylene ether resin used in the present invention may be either a synthetic product or a commercially available product. It is to be noted that the phenylene ether resin used in the present invention needs to satisfy the following conditions; namely, with regard to the percentage (%) of the number of polymerizable double bonding groups (A) [eq./g] and the number of hydroxyl groups (B) [eq./g] in the above general formula (1), (A)/(B)=95.0 to 99.5(%)/0.5 to 5.0(%).

Hereafter, a method for producing the phenylene ether resin represented by the above general formula (2), which has hydroxyl groups at both termini thereof, will be described, and thereafter, a method for producing the phenylene ether resin represented by the above general formula (2), which has polymerizable double bonding groups at both termini thereof, will be described.

The phenylene ether resin represented by the above general formula (2), which has hydroxyl groups at both termini thereof, can be efficiently produced by subjecting a single use of, or a mixture of, a divalent phenol represented by the following general formula (8) and a monovalent phenol represented by the following general formula (9) to oxidative polymerization in a toluene, or toluene-alcohol, or toluene-ketone, or ketone-based solvent.

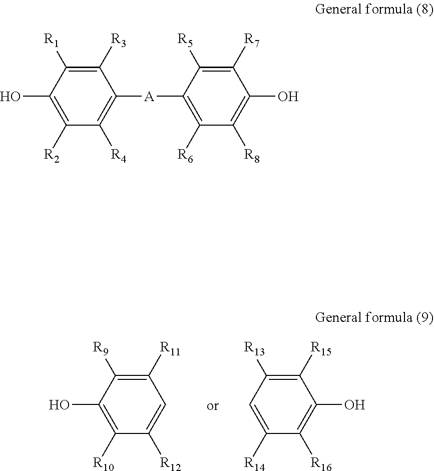

Herein, specific examples of the divalent phenol represented by the above general formula (8) may include 4,4′-methylenebis(2,6-dimethylphenol), 4,4′-(1-methylethylidene)bis[2,6-dimethylphenol], 4,4′-methylenebis(2,3,6-trimethylphenol), 4,4′-cyclohexylidenebis[2,6-dimethylphenol], 4,4′-(phenylmethylene)bis-2,3,6-trimethylphenol, 4,4′-[1,4-phenylenebis(1-methylethylidene)]bis[2,6-dimethylphenol], 4,4′-methylenebis[2,6-bis(1,1-dimethylethyl)phenol], 4,4′-cyclopentylidenebis[2,6-dimethylphenol], 4,4′-[2-furylmethylene]bis(2,6-dimethylphenol), 4,4′-[1,4-phenylenebismethylene]bis[2,6-dimethylphenol], 4,4′-(3,3,5-trimethylcyclohexylidene)bis[2,6-dimethylphenol], 4,4′-[4-(1-methylethyl)cyclohexylidene]bis[2,6-dimethylphenol], 4,4′-(4-methylphenylethylene)bis[2,3,6-trimethylphenol], 4,4′-[1,4-phenylenebismethylene]bis[2,3,6-trimethylphenol], 4-[1-[4-(4-hydroxy-3,5-dimethylphenyl)-4-methylcyclohexyl]-1-methylethyl]-2,6-dimethylphenol, 4,4′-(4-methoxyphenylmethylene)bis[2,3,6-trimethylphenol], 4,4′-[4-(1-methylethyl)phenylmethylene]bis[2,3,6-trimethylphenol], 4,4′-(9H-fluoren-9-ylidene)bis[2,6-dimethylphenol], 4,4′-[1,3-phenylenebis(1-methyl ethylidene)]bis[2,3,6-trimethylphenol], 4,4′-(1,2-ethanediyl)bis[2,6-di-(1,1-dimethylethyl)phenol], and 5,5′-(1-methylethylidene)bis[3-(1,1-dimethylethyl)-1,1-biphenyl-2-ol], but the examples of the divalent phenol represented by the above general formula (8) are not limited thereto.

Next, the monovalent phenol represented by the above general formula (9) is particularly preferably a single use of a phenol having substituents at positions 2 and 6, or a combined use of this phenol and a phenol having substituents at positions 3 and 5. In the case of a single use, 2,6-dimethylphenol is more preferable, and in the case of a combined use, 2,6-dimethylphenol and 2,3,6-trimethylphenol are preferable.

The number average molecular weight (Mn) of the phenylene ether resin used in the present invention is not particularly limited, and it is preferably 500 to 4000, and more preferably 800 to 3000. Moreover, the weight average molecular weight (Mw) thereof is not particularly limited, and it is preferably 500 to 8000, and more preferably 800 to 6000. The phenylene ether resin of the present invention is preferable because it can achieve both the dielectric property and solubility in a solvent by setting the Mn and Mw thereof to be within the above-described ranges.

As an oxidation method, there is a method of directly using oxygen gas or air. In addition, there is also an electrode oxidation method. All of these methods can be applied, and the oxidation method is not particularly limited. Among others, air oxidation is preferable because of its safety and low capital investment. Examples of the catalyst used in the case of performing oxidative polymerization using oxygen gas or air may include one or two or more types of copper salts and the like, such as CuCl, CuBr, Cu₂SO₄, CuCl₂, CuBr₂, CuSO₄, and CuI. In addition to the above-described catalysts, there are used one or two or more types of amines, such as mono- and dimethylamine, mono- and diethylamine, mono- and dipropylamine, mono- and di-n-butylamine, mono- and di-sec-dipropylamine, mono- and dibenzylamine, mono- and dicyclohexylamine, mono- and diethanolamine, ethylmethylamine, methylpropylamine, butyldimethylamine, allylethylamine, methylcyclohexylamine, morpholine, methyl-n-butylamine, ethylisopropylamine, benzylmethylamine, octylbenzylamine, octyl-chlorobenzylamine, methyl(phenylethyl)amine, benzylethylamine, N-n-butyldimethylamine, N,N′-di-tert-butylethylenediamine, di(chlorophenylethyl)amine, 1-methylamino-4-pentene, pyridine, methylpyridine, 4-dimethylaminopyridine, and piperidine. The catalysts used herein are not particularly limited to the aforementioned substances, as long as the catalysts are copper salts and amines.

As reaction solvents, aromatic hydrocarbon solvents such as toluene, benzene and xylene, halogenated hydrocarbon solvents such as methylene chloride, chloroform and carbon tetrachloride, etc. can be used in combination with alcohol or ketone solvents. Examples of the alcohol solvents may include methanol, ethanol, butanol, propanol, methyl propylene diglycol, diethylene glycol ethyl ether, butyl propylene glycol, and propyl propylene glycol, and also, examples of the ketone solvents may include acetone, methyl ethyl ketone, diethyl ketone, methyl butyl ketone, and methyl isobutyl ketone, and further, tetrahydrofuran and dioxane. However, examples of the reaction solvents are not limited thereto.

Next, the method for producing the phenylene ether resin represented by the above general formula (2), which has polymerizable double bonding groups at both termini thereof, will be described. The phenylene ether resin can be synthesized by subjecting a bifunctional resin having phenolic hydroxyl groups at the termini thereof represented by the above general formula (2) and a compound having a polymerizable double bonding group represented by the following general formula (10) or the following general formula (11) to a dehydrohalogenation reaction in the presence of a phase transfer catalyst under basic conditions.

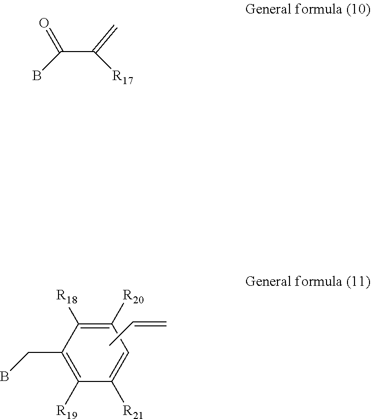

In the general formulae (10) and (11), B represents a halogen (i.e. a fluorine atom, a chlorine atom, a bromine atom, or an iodine atom). In the general formula (10), R₁₇ is as defined in the above general formula (3). In the general formula (11), R₁₈ to R₂₁ are as defined in the above general formula (4).

Representative examples of the phase transfer catalyst may include: tertiary amines such as triethylamine and tetramethylethylenediamine; and quaternary ammonium salts or quaternary phosphonium salts, such as tetrabutylammonium chloride, tetrabutylammonium bromide, tetrabutylammonium iodide, benzyltri-n-butylammonium chloride, benzyltri-n-butylammonium bromide, and benzyltri-n-butylammonium iodide, but the examples of the phase transfer catalyst are not limited thereto.

Representative examples of the base may include sodium hydroxide, potassium hydroxide, sodium methoxide, sodium ethoxide, calcium hydroxide, sodium carbonate, potassium carbonate, and sodium bicarbonate, but the examples of the base are not limited thereto.

The reaction is preferably carried out at a reaction temperature between −10° C. and 80° C.

<Petroleum resin>

In the resin composition of the first embodiment of the present invention, by allowing the present resin composition to contain a specific amount of a resin having phenolic hydroxyl groups at the termini thereof, melt viscosity is reduced, while suppressing dielectric dissipation factor. By adding a petroleum resin to the present resin composition, the melt viscosity can be further reduced.

The petroleum resin used in the present invention is a resin obtained by polymerization of components remaining after the thermal decomposition of petroleum naphtha and collection of necessary fractions in the absence or presence of a catalyst, without isolation of unsaturated hydrocarbons. The remaining fractions are mainly fractions including C5 fractions (isoprene, piperylene, cyclopentadiene, pentenes, pentanes, etc.) or C9 fractions (vinyl toluene, indene, dicyclopentadiene, etc.).

In the present invention, from the viewpoint of reducing melt viscosity by combination with a phenylene ether resin, it is preferable to use a petroleum resin made from C9 fraction monomers or dicyclopentadiene monomers as raw materials.

An acid catalyst is preferable as a catalyst used in the production of a petroleum resin. Specific examples of the acid catalyst that can be used herein may include: Lewis acids such as a boron trifluoride phenol complex, a boron trifluoride ether complex, aluminum chloride, aluminum bromide, iron(III) chloride, and iron(III) bromide; solid acids such as zeolite, silica, montmorillonite, and alumina; ion exchange resins such as a sulfonic acid group-containing fluororesin and a sulfonic acid group-containing polystyrene resin; and protic acids such as sulfuric acid, hydrochloric acid, acetic acid, phosphoric acid, oxalic acid, nitric acid, paratoluenesulfonic acid, and trifluoroacetic acid. Among these acids, Lewis acids and solid acids are preferable because they hardly cause side reactions and have a high reaction speed. Among others, various complexes comprising boron trifluoride, and aluminum chloride, are most preferable because they are easily available and highly reactive.

The weight average molecular weight of the petroleum resin used in the present invention is not particularly limited, and it is preferably 500 to 10000, and more preferably 500 to 5000. If the weight average molecular weight is higher than this value, the viscosity of the resin is high, and the resin is hardly compatible with the phenylene ether resin, and its solubility in a solvent may also be low. If the weight average molecular weight is lower than the aforementioned value, the heat resistance and mechanical strength of the resin may be decreased.

The softening point of the petroleum resin used in the present invention is not particularly limited, and it is preferably high, and it is preferably 80° C. or higher, and more preferably 100° C. or higher. If the softening point is lower than this value, the heat resistance of the resin may be decreased.

Examples of the dicyclopentadiene-based petroleum resin may include: resins obtained by polymerization of dicyclopentadiene-based fractions such as dicyclopentadiene, isopropenyl norbornene, dimethyldicyclopentadiene, or tricyclopentadiene; and resins obtained by polymerization of dicyclopentadiene-based fractions and other monomers having unsaturated bonds, preferably, unsaturated cyclic olefins.

Examples of the above-described unsaturated cyclic olefins may include: cyclopentadiene; norbornene-based monomers such as 2-norbornene, 5-methyl-2-norbornene, 5-ethylidene-2-norbornene, 5-phenylnorbornene, 5-propenyl-2-norbornene, and 5-ethylidene-2-norbornene; and further, norbornene-based monomers of tri- or more cyclic forms, such as tricyclic forms other than dicyclopentadiene-based fractions, such as diethyldicyclopentadiene and dihydrodicyclopentadiene, tetracyclic forms such as tetracyclododecene, pentacyclic forms such as tricyclopentadiene, heptacyclic forms such as tetracyclopentadiene, and alkyl-, alkylidene-, and aryl-substituted forms of these polycyclic forms. Examples of the alkyl-substituted form of the polycyclic form may include methyl-, ethyl-, propyl-, and butyl-substituted forms. In addition, the alkylidene-substituted form of the polycyclic form may be, for example, an ethylidene-substituted form. Further, examples of the aryl-substituted form of the polycyclic form may include phenyl-, tolyl-, and naphthyl-substituted forms.

Further, as other monomers having unsaturated bonds, an olefin containing 3 to 12 carbon atoms may be copolymerized. Examples thereof may include: α-olefins such as propylene, butene-1, pentene-1, 1,3-pentadiene, hexene-1, heptene-1, octene-1, diisobutylene, nonene-1, decene-1, 4-phenylbutene-1, 6-phenylhexene-1,3-methylbutene-1, 4-methylpentene-1, 3-methylpentene-1, 3-methylhexene-1, 4-methylhexene-1, 5-methylhexene-1, 3,3-dimethylpentene-1, 3,4-dimethylpentene-1, 4,4-dimethylpentene-1, vinylcyclohexane, and vinylcyclohexene; and halogen-substituted α-olefins such as hexafluoropropene, 2-fluoropropene, 3-fluoropropene, and 3,4-dichlorobutene-1.

Examples of other monomers having unsaturated bonds, other than the above-described monomers, may include: ethylene, tetrafluoroethylene, fluoroethylene, 1,1-difluoroethylene, and trifluoroethylene; alkyl styrenes such as styrene, p-methylstyrene, o-methylstyrene, m-methylstyrene, 2,4-dimethylstyrene, 2,5-dimethylstyrene, 3,4-dimethylstyrene, 3,5-dimethylstyrene, and p-t-butylstyrene; halogenated styrenes such as p-chlorostyrene, m-chlorostyrene, o-chlorostyrene, p-bromostyrene, m-bromostyrene, o-bromostyrene, p-fluorostyrene, m-fluorostyrene, o-fluorostyrene, and o-methyl-p-fluorostyrene; and maleic acid anhydride, maleic acid, fumaric acid, allyl alcohol, 3-buten-2-ol, methylbuten-1-ol, vinyl acetate, and vinyl chloride.

The above-described other monomers having unsaturated bonds may be used alone, or may also be used in combination of two or more types.

A commercially available petroleum resin can be used, as appropriate, as the petroleum resin used in the present invention. Examples of the aliphatic petroleum resin may include: Quintone (registered trademark) A100 (product name), Quintone (registered trademark) B170 (product name), Quintone (registered trademark) K100 (product name), Quintone (registered trademark) M100 (product name), Quintone (registered trademark) R100 (product name), and Quintone (registered trademark) C200S (product name), which are manufactured by Zeon Corporation; and Marukarets (registered trademark) T-100AS (product name), and Marukarets (registered trademark) R-100AS (product name), which are manufactured by Maruzen Petrochemical CO., LTD. Examples of the aromatic petroleum resin may include: Neopolymer L-90 (product name), Neopolymer 120 (product name), Neopolymer 130 (product name), Neopolymer 140 (product name), Neopolymer 150 (product name), Neopolymer 170S (product name), Neopolymer 160 (product name), Neopolymer E-100 (product name), Neopolymer E-130 (product name), Neopolymer 130S (product name), and Neopolymer S (product name), which are manufactured by JXTG Nippon Oil & Energy Corporation; and PETCOAL (registered trademark) LX, PETCOAL (registered trademark) LX-HS, PETCOAL (registered trademark) 100T (product name), PETCOAL (registered trademark) 120 (product name), PETCOAL (registered trademark) 120HS (product name), PETCOAL (registered trademark) 130 (product name), PETCOAL (registered trademark) 140 (product name), PETCOAL (registered trademark) 140HM (product name), PETCOAL (registered trademark) 140HM5 (product name), PETCOAL (registered trademark) 150 (product name), and PETCOAL (registered trademark) 150AS (product name), which are manufactured by TOSOH CORPORATION. Examples of the copolymerized petroleum resin may include: Quintone (registered trademark) D100 (product name), Quintone (registered trademark) N180 (product name), Quintone (registered trademark) P195N (product name), Quintone (registered trademark) S100 (product name), Quintone (registered trademark) S195 (product name), Quintone (registered trademark) U185 (product name), Quintone (registered trademark) G100B (product name), Quintone (registered trademark) G115 (product name), Quintone (registered trademark) D200 (product name), Quintone (registered trademark) E200SN (product name), and Quintone (registered trademark) N295 (product name), which are manufactured by Zeon Corporation; and PETROTAC (registered trademark) 60 (product name), PETROTAC (registered trademark) 70 (product name), PETROTAC (registered trademark) 90 (product name), PETROTAC (registered trademark) 90V (product name), PETROTAC (registered trademark) 100 (product name), PETROTAC (registered trademark) 100V (product name), and PETROTAC (registered trademark) 90HM (product name), which are manufactured by TOSOH CORPORATION. Examples of the DCPD (dicyclopentadiene)-based petroleum resin may include: Marukarets (registered trademark) M-890A (product name) and Marukarets (registered trademark) M-845A (product name), which are manufactured by Maruzen Petrochemical CO., LTD.; Quintone (registered trademark) 1325 (product name), Quintone (registered trademark) 1345 (product name), Quintone (registered trademark) 1500 (product name), Quintone (registered trademark) 1525L (product name), and Quintone (registered trademark) 1700 (product name), which are manufactured by Zeon Corporation; and T-REZ HA085, T-REZ HA103, T-REZ HA105 (product name), T-REZ HA125 (product name), T-REZ HB103 (product name), and T-REZ HB125 (product name), which are manufactured by ENEOS Corporation.

### <Other Components>

The resin composition of the first embodiment of the present invention mainly comprises a phenylene ether resin and a petroleum resin. The present resin composition may also comprise other components as described below, as appropriate.

The resin composition of the present invention can be cured by heating the resin composition itself, but a thermosetting catalyst can be added to the present resin composition for the purpose of accelerating the curing speed and improving workability and economic efficiency. As such a thermosetting catalyst, there can be used a thermosetting catalyst that can generate a cationic or radical active species capable of initiating the polymerization of vinyl groups by heat or light. Examples of the cationic polymerization initiator may include diallyliodonium salts, triallylsulfonium salts, and aliphatic sulfonium salts, each having BF₄, PF₆, AsF₆, and SbF₆ as counter anions. The following commercially available products can be used as such cationic polymerization initiators: SP70 (product name), SP172 (product name) and CP66 (product name) manufactured by ADEKA; CI2855 (product name) and CI2823 (product name) manufactured by Nippon Soda Co., Ltd.; and SAN-AID (registered trademark) SI100L (product name) and SAN-AID (registered trademark) SI150L (product name) manufactured by SANSHIN CHEMICAL INDUSTRY CO., LTD. Examples of the radical polymerization initiator may include: benzoin compounds such as benzoin and benzoinmethyl; acetophenone compounds such as acetophenone and 2,2-dimethoxy-2-phenylacetophenone; thioxanthone compounds such as thioxanthone and 2,4-diethylthioxanthone; bisazide compounds such as 4,4′-diazidochalcone, 2,6-bis(4′-azidobenzal)cyclohexanone, and 4,4′-diazidobenzophenone; azo compounds such as azobisisobutyronitrile, 2,2-azobispropane, and hydrazone; and organic peroxides such as 2,5-dimethyl-2,5-di(t-butylperoxy)hexane, 2,5-dimethyl-2,5-di(t-butylperoxy)hexine-3, and dicumyl peroxide. In addition, PERBUTYL (registered trademark) P (product name) manufactured by NOF CORPORATION can also be preferably used. These curing catalysts can be used alone, or can also be used in a mixture of two or more types.

In order to increase preservation stability, a polymerization inhibitor can also be added to the resin composition of the present invention. As such a polymerization inhibitor, a known polymerization inhibitor can be generally used, and examples of the polymerization inhibitor may include: quinones such as hydroquinone, methylhydroquinone, p-benzoquinone, chloranil, and trimethylquinone; and aromatic diols. Moreover, as such polymerization inhibitors, dibutylhydroxytoluene (BHT), 4-tert-butylcatechol (TBC), 2-nitrophenol and the like can also be preferably used. These polymerization inhibitor can be used alone, or can also be used in a mixture of two or more types.

One or more additives selected from a crosslinking agent, a flame retardant, a filler of an inorganic or organic material and a coupling agent can be added to the resin composition of the present invention, as necessary. In addition, common additive components for resin compositions, which are used in the production of electronic devices such as printed wiring boards, may also be added.

From the viewpoint of a crosslinking reaction, the crosslinking agent preferably has, on average, two or more carbon-carbon unsaturated double bonds or isocyanate groups in a single molecule thereof. The crosslinking agent may be composed of one type of compound, or may also be composed of two or more types of compounds. The term “carbon-carbon unsaturated double bond” is used in the present description to mean a double bond located at an end branched from a main chain, when the crosslinking agent is a polymer or an oligomer.

Examples of the crosslinking agent may include an alkenyl isocyanurate compound, an alkenyl cyanurate compound, a polyfunctional methacrylate compound having two or more methacryl groups in a molecule thereof, a polyfunctional acrylate compound having two or more acryl groups in a molecule thereof, a polyfunctional vinyl compound having two or more vinyl groups in a molecule thereof, a polyfunctional vinylphenyl compound having two or more vinylphenyl groups in a molecule thereof, a styrene derivative, a polyfunctional maleimide compound having two or more maleimide groups in a molecule thereof, and a polyfunctional isocyanate compound having an isocyanate group in a molecule thereof.

The above-described alkenyl isocyanurate compound is not particularly limited, as long as it is a compound having an isocyanurate structure and an alkenyl group in a molecule thereof. Examples of the alkenyl isocyanurate compound may include trialkenyl isocyanurate compounds such as triallyl isocyanurate (e.g. TAICROS (registered trademark) manufactured by Evonik Japan Co., Ltd.).

The above-described alkenyl cyanurate compound is not particularly limited, as long as it is a compound having a cyanurate structure and an alkenyl group in a molecule thereof. Examples of the alkenyl cyanurate compound may include trialkenyl cyanurate compounds such as triallyl cyanurate (e.g. TAC, Evonik Japan Co., Ltd.).

The above-described polyfunctional methacrylate compound may be, for example, tricyclodecanedimethanol dimethacrylate (e.g. NK Ester DCP (product name), manufactured by SHIN-NAKAMURA CHEMICAL Co., Ltd.).

The above-described polyfunctional vinyl compound may be, for example, a polybutadiene resin. The polybutadiene resin is a polymer synthesized with butadiene monomers, such as a butadiene homopolymer, or a copolymer of butadiene with another monomer. Preferred examples of the polyfunctional vinyl compound may include: Ricon (registered trademark) 100 (product name), Ricon (registered trademark) 181 (product name), and Ricon (registered trademark) 184 (product name), which are manufactured by Cray Valley; and B-1000 (product name), B-2000 (product name), and B-3000 (product name), which are manufactured by Nippon Soda Co., Ltd.

Examples of the above-described polyfunctional vinylphenyl compound may include divinylbenzene (e.g. DVB-960, DVB-810, and DVB-630, manufactured by NIPPON STEEL Chemical & Material Co., Ltd.), ethylstyrene, ethynylbenzene, and ODV-XET, manufactured by NIPPON STEEL Chemical & Material Co., Ltd.

Examples of the above-described styrene derivative may include bromostyrene and dibromostyrene.

Examples of the above-described maleimide compound may include a compound having two or more maleimide groups in a molecule thereof, a compound having one maleimide group in a molecule thereof, and a modified maleimide compound. Among these compounds, a compound having two or more maleimide groups in a molecule thereof is preferably used. Examples of the above-described modified maleimide compound may include a modified maleimide compound, in which some molecules are modified with amines, and a modified maleimide compound, in which some molecules are modified with amines and silicones.

Examples of the modified maleimide compound may include: (4,4′-methylenediphenyl)bismaleimide (e.g. BMI-70 (product name) manufactured by K.I Chemical Industry Co., LTD., and BMI-1000 (product name), BMI-1000H (product name), BMI-1000S (product name), BMI-1100 (product name) or BMI-1100H (product name) manufactured by Daiwa Kasei Industry Co., Ltd.); phenylmaleimide oligomers (e.g. BMI-2300 (product name) manufactured by Daiwa Kasei Industry Co., Ltd.), m-phenylenebismaleimide (e.g. BMI-3000 (product name) manufactured by Daiwa Kasei Industry Co., Ltd.), and 2,2-bis-[4-(4-maleimidophenoxy)phenyl]propane (e.g. BMI-80 (product name) manufactured by K.I Chemical Industry Co., LTD., and BMI-4000 (product name) manufactured by Daiwa Kasei Industry Co., Ltd.); 3,3′-dimethyl-5,5′-diethyl-4,4′-diphenylethane bismaleimide (e.g. BMI-5100 (product name) manufactured by Daiwa Kasei Industry Co., Ltd.); (4-methyl-1,3′-phenylene)bismaleimide (e.g. BMI-7000H (product name) manufactured by Daiwa Kasei Industry Co., Ltd.); 1,6-bismaleimide(2,2,4-trimethyl)hexane (e.g. BMI-TMH (product name) manufactured by Daiwa Kasei Industry Co., Ltd.); and phenylmaleimide oligomers (e.g. MIR-3000-70MT (product name) manufactured by Daiwa Kasei Industry Co., Ltd.).

With regard to the above-described crosslinking agent, the exemplified crosslinking agents may be used alone or may also be used in combination of two or more types. In addition, with regard to the above-described crosslinking agent, not only the above-described crosslinking agents, such as the above-described compound having two or more unsaturated double bonds in a molecule thereof, may be used, but a compound having one unsaturated double bond in a molecule thereof may also be used in combination. The above-described compound having one unsaturated double bond in a molecule thereof may be, for example, a monovinyl compound having one vinyl group in a molecule thereof.

With regard to the mass ratio among the above-described phenylene ether resin, the above-described petroleum resin, and the above-described crosslinking agent in the resin composition of the first embodiment of the present invention, it is preferably the phenylene ether resin/(the petroleum resin+the crosslinking agent)=90/10 to 30/70, and more preferably 70/30 to 40/60. By setting the content of the crosslinking agent within the above-described range, the value of the minimum melt viscosity [Pa·s]can be effectively reduced.

Brominated organic compounds, such as aromatic bromine compounds, can be used as flame retardants. Specifically, decabromodiphenylethane, 4,4-dibromobiphenyl, ethylenebistetrabromophthalimide, etc. can be used. Preferably, the brominated organic compound may be contained in an amount of 8% by mass or more and 20% by mass or less, with respect to the total amount of the resin composition.

If the bromine content becomes smaller than the lower limit, the flame retardancy of a prepreg is decreased and the UL 94V-0 level of flame retardancy may not be maintained in some cases. On the other hand, if the bromine content becomes larger than the upper limit, the bromine is easily dissociated during the heating of the prepreg, and the heat resistance of the prepreg may be decreased in some cases.

Moreover, from the viewpoint of environmental issues, a phosphorus compound may also be used as a flame retardant. Among phosphorus compounds that are generally used as flame retardants, the phosphorus compounds used herein are not particularly limited, as long as they comprise phosphorus atoms.

Either inorganic phosphorus compounds or organic phosphorus compounds may be used.

Examples of the inorganic phosphorus compounds may include red phosphorus, ammonium phosphate, amide phosphate, phosphoric acid, and phosphine oxide.

Examples of the organic phosphorus compounds may include aromatic phosphoric acid esters, substituted phosphinic acid esters, nitrogen-containing phosphorus compounds, and cyclic organic phosphorus compounds.

The flame retardants may be used alone, or may also be used in combination with two or more types.

Examples of the filler may include: fibrous fillers such as glass fiber, carbon fiber, aramid fiber, silicon carbide fiber, alumina fiber, and boron fiber; inorganic whiskers such as silicon carbide, silicon nitride, magnesium oxide, potassium titanate, and aluminoborate; inorganic needle fillers such as wollastonite, zonolite, phosphate fiber, and sepiolite; spherical inorganic fillers such as milled silica, fused silica, talc, alumina, barium titanate, mica, and glass beads; and organic fillers such as fine particle polymers obtained by cross-linking (meth)acrylic acid esters, styrene, or the like. These fillers can be used alone, or can also be used in a mixture of two or more types.

By adding a filler made of an inorganic material (hereinafter referred to as an “inorganic filler”) to the present resin composition, the thermal expansion coefficient of a prepreg produced using the present resin composition can be reduced, and the stiffness of the prepreg can be improved. Examples of the inorganic filler that can be used herein may include metal oxides, nitrides, silicides, and borides, such as silica, boron nitride, wollastonite, talc, kaolin, clay, mica, alumina, zirconia, and titania. In particular, by adding a low dielectric constant filler such as silica or boron nitride, the dielectric constant of the resin composition can be reduced.

By adding a filler made of an organic material (hereinafter referred to as an “organic filler”) to the present resin composition, the dielectric constant of a prepreg produced using the present resin composition can be reduced. Examples of the organic filler that can be used herein may include fluorine-based, polystyrene-based, divinylbenzene-based, and polyimide-based organic fillers. Examples of the fluorine-based filler (i.e. a filler consisting of a fluorine-containing compound) may include polytetrafluoroethylene (PTFE), a polyperfluoroalkoxy resin, a polyfluorinated ethylenepropylene resin, a polytetrafluoroethylene-polyethylene copolymer, polyvinylidene fluoride, and a polychlorotrifluoroethylene resin. These organic fillers can be used alone, or can also be used in combination of multiple fillers.

In addition, as such organic fillers, hollow polymer fine particles can be used. In particular, by using a hollow body whose shell material is a low dielectric constant material such as divinylbenzene or divinylbiphenyl, the low dielectric constant of a prepreg can be realized.

As an inorganic filler or an organic filler, fine particles with an average particle diameter of 10 μm or less can be used. The average particle diameter adopted herein may be the value described in documents such as the catalog of the filler to be added, or it may also be the average or median value of multiple fillers that are randomly selected. By setting the average particle diameter of the filler to be under the above-described conditions, a prepreg having high smoothness and reliability can be obtained.

Examples of the coupling agent may include: silane coupling agents such as vinyltrichlorosilane, vinyltriethoxysilane, vinyltrimethoxysilane, γ-methacryloxypropyltrimethoxysilane, β-(3,4-epoxycyclohexyl)ethyltrimethoxysilane, γ-glycidoxypropylmethyldiethoxysilane, N-β-(aminoethyl)-γ-aminopropylmethylmethoxysilane, γ-aminopropyltriethoxysilane, N-phenyl-γ-aminopropyltrimethoxysilane, γ-mercaptopropyltrimethoxysilane, and γ-chloropropyltrimethoxysilane; titanate coupling agents, aluminum coupling agents, zircoalminate coupling agents, silicone coupling agents, and fluorine coupling agents. These coupling agents can be used alone, or can also be used in a mixture of two or more types.

### Second Embodiment

A second embodiment of the present invention is a resin composition comprising a phenylene ether resin, a petroleum resin, and a thermoplastic elastomer. The phenylene ether resin and the petroleum resin are as described in the first embodiment. In addition, [Other components] described in the first embodiment can also be used in the second embodiment. According to the second embodiment of the present invention, there can be provided a resin composition exhibiting an excellent dielectric property (low dielectric dissipation factor), having a reduced melt viscosity, and having an increased peel strength.

The dielectric dissipation factor (Df) at 10 GHz of a cured product of the resin composition of the second embodiment is preferably 0.0040 or less, and more preferably 0.0025 or less.

The peel strength of the copper foil of a laminated plate obtained from the resin composition of the second embodiment is preferably 0.4 kg/cm or more, and more preferably 0.6 kg/cm or more.

From the viewpoint of heat resistance, the higher the glass transition point (Tg) of a cured product of the resin composition of the second embodiment, more preferable it is. The glass transition point is preferably 180° C. or higher, and more preferably 200° C. or higher.

The resin composition of the second embodiment has a minimum melt viscosity that is preferably at least 5% lower than, and is more preferably 10% to 50% lower than, a resin composition comprising the same components as those of the present resin composition, except that it does not comprise a petroleum resin.

Besides, as methods of measuring dielectric dissipation factor, peel strength, glass transition point, and melt viscosity, the methods described in the Examples as mentioned later can be adopted.

### <Thermoplastic Elastomer>

The peel strength of the resin composition of the second embodiment of the present invention can be improved by allowing the present resin composition to comprise a thermoplastic elastomer.

As a thermoplastic elastomer used in the present invention, a commercially available thermoplastic elastomer can be used, as appropriate, and examples thereof may include: butadiene-based thermoplastic elastomers such as a styrenebutadiene copolymer(SBR) and an acrylonitrilebutadiene copolymer; styrene-based thermoplastic elastomers such as a styrenebutadienestyrene copolymer (SBS), a hydrogenated styrenebutadienestyrene copolymer, a styreneisoprenestyrene copolymer (SIS), a hydrogenated styreneisoprenestyrene copolymer, and a hydrogenated styrene(butadiene/isoprene)styrene copolymer; and thermoplastic resins such as polystyrene, polyester, and polycarbonate. Specific examples of the thermoplastic elastomer may include: TR2003 manufactured by JSR; SEPTON (registered trademark) 1020 (product name), SEPTON (registered trademark) 4033 (product name), SEPTON (registered trademark) 2104 (product name), SEPTON (registered trademark) 8007L (product name), HYBRAR (registered trademark) 5127 (product name), and HYBRAR (registered trademark) 7311F (product name), which are manufactured by KURARAY CO., LTD.; OP501, HA105, HA125, NB125, and PR803, which are manufactured by ENEOS Corporation; and Quintone (registered trademark) 1340 (product name) and Quintone (registered trademark) 2940 (product name), which are manufactured by Zeon Corporation.

Among these thermoplastic elastomers, styrene-based thermoplastic elastomers such as a styrenebutadienestyrene copolymer, a hydrogenated styrenebutadienestyrene copolymer, a styreneisoprenestyrene copolymer, a hydrogenated styreneisoprenestyrene copolymer, and a hydrogenated styrene(butadiene/isoprene)styrene copolymer are preferable. In particular, a styreneisoprenestyrene copolymer, a hydrogenated styrenebutadienestyrene copolymer, a hydrogenated styreneisoprenestyrene copolymer, and a hydrogenated styrene(butadiene/isoprene)styrene copolymer are more preferable because higher heat resistance can be obtained.

These thermoplastic elastomers may be used alone, or may also be used in combination of two or more types.

When a styrene-based thermoplastic elastomer is used, the content of styrene in the elastomer is not particularly limited. When higher heat resistance is intended to be obtained, the content of styrene in the elastomer is preferably 10% to 70% by mass, and more preferably 10% to 50% by mass. In addition, the weight average molecular weight of the styrene-based thermoplastic elastomer is not particularly limited, as long as it is 10000 or more. However, since the mixing of the styrene-based thermoplastic elastomer with the phenylene ether resin becomes difficult if the weight average molecular weight of the styrene-based thermoplastic elastomer is too large, it is preferably 10000 to 300000.

With regard to the mass ratio among the above-described phenylene ether resin, the above-described petroleum resin, and the above-described thermoplastic elastomer in the resin composition of the second embodiment, it is preferably the phenylene ether resin/(the petroleum resin+the thermoplastic elastomer)=90/10 to 50/50, and more preferably 70/30 to 50/50. If the total amount of the petroleum resin and the thermoplastic elastomer is less than 30% by mass, the effect of reducing melt viscosity and the effect of improving peel strength may be reduced. On the other hand, if the total amount of the petroleum resin and the thermoplastic elastomer exceeds 50% by mass, the contribution of the thermoplastic elastomer may become too large and the melt viscosity may become too high in some cases.

With regard to the mass ratio among the above-described phenylene ether resin, the above-described petroleum resin, the above-described crosslinking agent, and the above-described thermoplastic elastomer in the resin composition of the second embodiment of the present invention, it is preferably the phenylene ether resin/(the petroleum resin+the crosslinking agent+the thermoplastic elastomer)=90/10 to 30/70, and more preferably 70/30 to 40/60. By setting the content of the crosslinking agent within the above-described range, the value of the minimum melt viscosity [Pa·s]can be effectively reduced.

### [Curable Film]

Next, the curable film of the present invention will be described. The curable film of the present invention is obtained by processing the resin composition of the present invention into a film. As a method of processing the present resin composition into a film, there may be applied, for example, a method comprising dissolving the resin composition in a solvent, applying the obtained solution onto a release film or a conductor foil such as a copper foil, and drying it.

Examples of the solvent used herein may include, but are not limited to, acetone, methyl ethyl ketone, ethylene glycol monomethyl ether acetate, propylene glycol dimethyl ether, toluene, xylene, tetrahydrofuran, and N,N-dimethylformamide. In addition, these solvents can be used alone, or can also be used in a mixture of two or more types.

Drying conditions applied upon the drying of the solvent are not particularly limited. The solvent easily remains in the curable film at a low temperature, while the hardening of the phenylene ether resin progresses at a high temperature. Accordingly, the solvent is preferably dried at a temperature of 80° C. to 200° C. for 1 to 90 minutes. The thickness of the curable film can be adjusted by the concentration of the resin composition solution and the thickness of the resin composition solution applied. Since the solvent easily remains upon the drying if the thickness of the resin composition solution increases, the thickness of the curable film is preferably 0.1 to 500 μm.

### [Prepreg]

A method for producing the prepreg according to the embodiment of the present invention will be described. First, a phenylene ether resin, a petroleum resin, and as necessary, other additives are mixed with an organic solvent to form a varnish. The organic solvent used herein is not particularly limited, as long as it dissolves the resin components and does not affect the reaction. For example, suitable organic solvents including aromatic hydrocarbons such as toluene, ketones such as methyl ethyl ketone, ethers such as dibutyl ether, esters such as ethyl acetate, and amides such as dimethylformamide, are used alone as a single type, or in a mixture of two or more types.

The concentration of resin solids in the varnish may be adjusted, as appropriate, depending on the operation of impregnating a base material with the varnish, and the concentration of the resin solids can be set to be, for example, 40% by mass or more and 90% by mass or less.

A prepreg can be obtained by impregnating a base material with the above-described varnish, then heating and drying the base material to remove the organic solvents, and at the same time, semi-curing the resin in the base material. In the prepreg according to the present invention, a glass cloth can be used, for example, as a base material.

The amount of the varnish impregnated into the base material is preferably set, such that the mass percentage of the resin solids in the prepreg can be 35% by mass or more. Since the dielectric constant of the base material is larger than the dielectric constant of the resin, in order to decrease the dielectric constant of a printed wiring board obtained using this prepreg, the content of the resin solids in the prepreg may be set to be larger than the above-described mass percentage. The base material impregnated with the varnish can be heated at a temperature of 80° C. or higher and 200° C. or lower for 1 minute or more and 10 minutes or less. At this time, the heating is carried out, so that the minimum melt viscosity of the resin composition in the prepreg can be 10000 Pa·s or less. For example, when the heating is carried out at a temperature of 150° C., the heating time is desirably 3 minutes or more and less than 10 minutes, and more desirably 5 minutes or more and 9 minutes or less. The heating conditions of the base material impregnated with the varnish are not limited to the above-described conditions, and are determined so that the minimum melt viscosity of the resin composition in the prepreg can be 10000 Pa·s or less. Herein, the minimum melt viscosity of the resin composition in the prepreg means the lowest value of the melt viscosity of the resin composition in the prepreg in a temperature range from room temperature to 200° C.

When the heating is carried out at a low temperature for a short time, the melt viscosity is decreased due to the remaining of the solvent, and in some cases, the dielectric dissipation factor of a laminated plate may be deteriorated. On the other hand, when the heating is carried out at a high temperature for a long time, curing progresses, and the melt viscosity may become too high in some cases. Accordingly, from the viewpoints of a reduction in the amount of the remaining solvent and suppression of an increase in the melt viscosity by heating, the minimum melt viscosity of the resin composition before the heating is desirably low.

A cured product of the resin composition in the thus formed prepreg has a dielectric constant Dk at 10 GHz of desirably 2.7 or less, and more desirably 2.5 or less. Moreover, the cured product has a dielectric dissipation factor Df at 10 GHz of desirably 0.0040 or less, and more desirably 0.0025 or less.

### [Base Material]

The base material is not particularly limited, and a known baes material used for various types of printed wiring board materials can be selected and used, as appropriate, depending on the desired intended use and performance. Specific examples of fibers that constitute the base material are not particularly limited. Examples of the fibers may include: glass fibers such as E-glass, D-glass, S-glass, Q-glass, NE-glass, L-glass, and T-glass; inorganic fibers other than glasses, such as quartz; wholly aromatic polyamides such as polyparaphenylene terephthalamide (Kevlar (registered trademark), manufactured by Du Pont K.K.), and copolyparaphenylene-3,4′oxydiphenylene-terephthalamide (Technora (registered trademark), manufactured by Teijin Techno Products Limited); polyesters such as 2,6-hydroxynaphthoic acid-parahydroxybenzoic acid (Vectran (registered trademark), manufactured by KURARAY CO., LTD.), and Zxion (registered trademark), manufactured by KB Seiren, Ltd.); and organic fibers such as polyparaphenylene benzoxazole (Zylon (registered trademark), manufactured by TOYOBO CO., LTD.), and polyimide. Among these, at least one type selected from the group consisting of E-glass, T-glass, S-glass, Q-glass, and organic fibers is preferable from the viewpoint of low thermal expansion coefficient. These base materials may be used alone as a single type, or may also be used in combination of two or more types.

The shape of the base material is not particularly limited, and examples of the shape of the base material may include a woven fabric, a non-woven fabric, roving, a chopped strand mat, and a surfacing mat. The method of weaving woven fabrics is not particularly limited. For example, plain weave, nanako weave, and twill weave are known, and the weaving method applied herein can be selected and used from among these known weaving methods, as appropriate, depending on the desired intended use and performance. Also, these woven fabrics, which are subjected to a fiber-opening treatment, or glass woven fabrics, which are subjected to a surface treatment with a silane coupling agent, are preferably used. The thickness and mass of the base material are not particularly limited, and in general, a base material with a size of about 0.01 to 0.3 mm is preferably used. In particular, from the viewpoints of strength and water absorbency, a glass woven fabric with a thickness of 200 μm or less and a mass of 250 g/m² or less is preferable, and a glass woven fabric consisting of glass fibers of E-glass, S-glass, and T-glass is more preferable.

### [Laminated Plate]

Hereafter, a method for producing a laminated plate using the above-prepared prepreg will be described. First, one prepreg is placed, or multiple prepregs are stacked on one another, and then, metallic foils such as copper foils are stacked on both surfaces or one surface of the prepreg, and the thus laminated plate is then molded by heating and pressurizing. By this molding process, a laminated plate having metallic foils on both surfaces or on one surface thereof (for example, a copper-clad laminated plate) can be produced. By patterning and etching the metallic foils of this laminated plate to form circuits, a printed wiring board can be obtained. In addition, a multi-layered printed wiring board can be produced by stacking multiple prepregs on one another while sandwiching the circuit-formed metallic foils between them, and then molding the resulting prepreg by heating and pressurizing.

Conditions for the molding by heating and pressurizing are different, depending on the content percentage of the raw materials of the resin composition according to the present invention. In general, it is preferable to perform heating and pressurizing for an appropriate period of time under conditions of a temperature of 170° C. or higher and 230° C. or lower, and a pressure of 1.0 MPa or more and 6.0 MPa or less (10 kg/cm² or more and 60 kg/cm² or less).

As a metallic foil used for the above-described laminated plate, there can be used a copper foil having a surface roughness (10-point average roughness: Rz) of 10 μm or less, wherein the surface of the side on which a resin layer is formed with a prepreg (the surface of the side that contacts with the prepreg) is treated with zinc or zinc alloy to prevent rust and to improve adhesion with the resin layer, and the surface is further subjected to a coupling treatment with a vinyl group-containing silane coupling agent, etc. Such a copper foil adheres well to the resin layer (insulation layer), and a printed wiring board having excellent high-frequency properties can be obtained. When the copper foil is treated with zinc or zinc alloy, the zinc or the zinc alloy can be formed on the surface of the copper foil by a plating method.

The thus obtained laminated plate or printed wiring board can realize low dielectric constant and low dielectric dissipation factor. Moreover, a laminated plate or a printed wiring board, having high moldability, high water resistance, high moisture resistance, high moisture absorption heat resistance, and high glass transition point, can be obtained. In particular, when the minimum melt viscosity of the prepreg is 10000 Pa·s or less, good moldability can be obtained.

### EXAMPLES

Hereinafter, the Examples and Comparative Examples of the present invention will be described, and the contents of the present invention will be described in detail. However, these examples are not intended to limit the scope of the present invention.

### <Synthesis of Phenylene Ether Resin>

### Synthetic Example 1

Into a 12-L vertical reactor equipped with a stirring device, a thermometer, an air introduction tube and a baffle board, 9.36 g (42 mmol) of CuBr₂, 1.81 g (11 mmol) of N,N′-di-t-butylethylenediamine, 67.8 g (670 mmol) of n-butyldimethylamine, and 2600 g of toluene were added, and the obtained mixture was then stirred at a reaction temperature of 40° C. To this reaction mixture, a mixed solution consisting of 129.3 g (0.48 mol) of 2,2′,3,3′,5,5′-hexamethyl-(1,1′-biphenyl)-4,4′-diol, 878 g (7.2 mol) of 2,6-dimethylphenol, 1.22 g (7.2 mmol) of N,N′-di-t-butylethylenediamine and 26.4 g (261 mmol) of n-butyldimethylamine, which had previously been dissolved in 2300 g of methanol, was added dropwise over 230 minutes, while bubbling, at a flow rate of 5.2 L/min, a mixed gas prepared by mixing nitrogen with air and adjusting the oxygen concentration to 8%, and the thus obtained mixture was stirred.

After completion of the dropwise addition, 1500 g of water, in which 48.1 g (130 mmol) of tetrasodium ethylenediaminetetraacetate was dissolved, was added to the reaction mixture, so as to terminate the reaction. A water layer was separated from an organic layer, and the organic layer was then washed with a 1 N hydrochloric acid aqueous solution, and then with pure water. The obtained solution was concentrated to 50% by mass, using an evaporator, and 1980 g of a toluene solution A of phenylene ether resin was obtained. The number average molecular weight relative to polystyrene standard according to the GPC method was 1975, and the weight average molecular weight relative to polystyrene standard according to the GPC method was 3514. The hydroxyl group equivalent was 990 g/eq.

Into a reactor equipped with a stirring device, a thermometer and a reflux tube, 833 g of the above-obtained toluene solution A of phenylene ether resin, 76.7 g (0.50 mol) of vinylbenzyl chloride (“CMS-P,” manufactured by AGC SEIMI CHEMICAL CO., LTD.), 1600 g of methylene chloride, 6.20 g (0.046 mol) of benzyldimethylamine, 200 g of pure water, and 84 g of NaOH aqueous solution (30.5% by mass) were added, and the obtained mixture was then stirred at a reaction temperature of 40° C. After the stirring had been performed for 24 hours, the organic layer was washed with a 1 N hydrochloric acid aqueous solution, and then with pure water. The obtained solution was concentrated, and the concentrate was then added dropwise into methanol for solidification. The solid was recovered by filtration and was then vacuum-dried to obtain 450 g of phenylene ether resin (i) comprising, as a main component, a resin represented by a structural formula shown below. The number average molecular weight relative to polystyrene standard according to the GPC method was 2250, and the weight average molecular weight relative to polystyrene standard according to the GPC method was 3920. The vinyl group double bond equivalent was 1189 g/eq., and the hydroxyl group equivalent was 56250 g/eq.

This phenylene ether resin (i) produced in Synthetic Example 1 was used in Comparative Example 3, Examples 1 to 3, Comparative Example 6, Examples 8 to 10, Comparative Examples 9 and 10, and Examples 17 and 18.

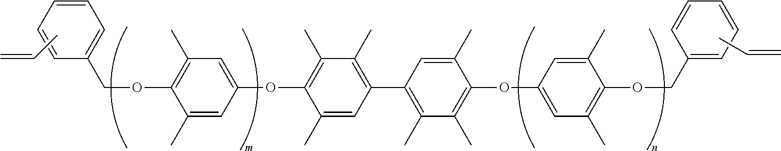

### Synthetic Example 2

285 g of Phenylene ether resin (ii) comprising, as a main component, the resin represented by the above structural formula was obtained in the same manner as that of Synthetic Example 1, with the exception that the amount of 2,6-dimethylphenol was changed to 342 g (2.8 mol) in Synthetic Example 1. The number average molecular weight relative to polystyrene standard according to the GPC method was 1200, and the weight average molecular weight relative to polystyrene standard according to the GPC method was 1800. The vinyl group double bond equivalent was 620 g/eq., and the hydroxyl group equivalent was 18750 g/eq.

This phenylene ether resin (ii) produced in Synthetic Example 2 was used in Comparative Example 4, Examples 4 to 6, Comparative Example 7, and Examples 11 to 13.

### Synthetic Example 3

290 g of Phenylene ether resin (iii) comprising, as a main component, the resin represented by the above structural formula was obtained in the same manner as that of Synthetic Example 1, with the exception that the amount of vinylbenzyl chloride was changed to 60.7 g (0.40 mol) in Synthetic Example 1. The number average molecular weight relative to polystyrene standard according to the GPC method was 2048, and the weight average molecular weight relative to polystyrene standard according to the GPC method was 3567. The vinyl group double bond equivalent was 1250 g/eq., and the hydroxyl group equivalent was 11250 g/eq.

This phenylene ether resin (iii) produced in Synthetic Example 3 was used in Comparative Examples 1 and 2.

Hereafter, Examples 8 and 15, which are representative examples of the present invention, will be described in detail.

### Example 8

60 Parts by mass of the phenylene ether resin (i) obtained in accordance with Synthetic Example 1, 10 parts by mass of a petroleum resin (PETROTAC 90V, manufactured by TOSOH CORPORATION), and 30 parts by mass of a thermoplastic elastomer represented by a structural formula shown below (SEPTON4033, manufactured by KURARAY CO., LTD.) were placed in an eggplant flask, and toluene was then added thereto, so that these components were completely dissolved in the toluene. Thereafter, the obtained solution was subjected to vacuum concentration to obtain a resin composition as a mixture of the 3 components. The evaluation results of the obtained resin composition are shown in Table 2 below.

The resin compositions of Examples 1 to 6 and 9 to 13 and Comparative Examples 1 to 4, 6 and 7 were obtained in the same manner as that of Example 8, with the exception that the used components and contents were changed to those shown in Table 1 and Table 2 below.

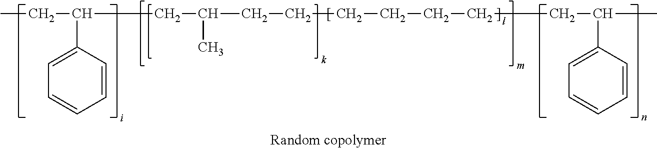

### Example 15

60 Parts by mass (hydroxyl group equivalent: 90909 g/eq.; vinyl group double bond equivalent: 1011 g/eq.) of Noryl SA9000 (manufactured by SABIC Japan Llc.) comprising, as a main component, a resin represented by a structural formula shown below, which was used as a phenylene ether resin, PERBUTYLP (manufactured by NOF CORPORATION) used as a polymerization initiator in an amount of 1.5 parts by mass with respect to the mass of Noryl SA9000, 20 parts by mass of a petroleum resin (HA125, manufactured by ENEOS Corporation), and 20 parts by mass of the thermoplastic elastomer represented by the above structural formula (SEPTON4033, manufactured by KURARAY CO., LTD.) were placed in an eggplant flask, and toluene was then added thereto, so that the components were completely dissolved in the toluene. Thereafter, the obtained solution was subjected to vacuum concentration to obtain a resin composition as a mixture of the 3 components. The evaluation results of the obtained resin composition are shown in Table 2 below.

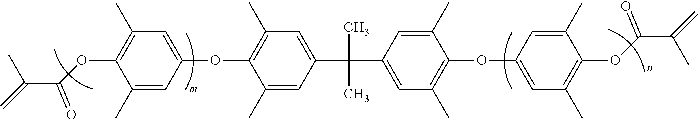

The resin compositions of Examples 7, 14 and 16 and Comparative Examples 5 and 8 were obtained in the same manner as that of Example 15, with the exception that the used components and contents were changed to those shown in Table 1 and Table 2 below.

### Example 17

60 Parts by mass of the phenylene ether resin (i) obtained in accordance with Synthetic Example 1, 20 parts by mass of the petroleum resin (PETROTAC 90V, manufactured by TOSOH CORPORATION), and 20 parts by mass of a bismaleimide compound (BMI-70, K.I Chemical Industry Co., LTD.) used as a crosslinking agent were placed in an eggplant flask, and toluene and methyl ethyl ketone were then added thereto, so that these components were completely dissolved in the solvents. Thereafter, the obtained solution was subjected to vacuum concentration to obtain a resin composition as a mixture of the 3 components. The evaluation results of the obtained resin composition are shown in Table 3 below. The resin composition of Comparative Example 9 was obtained in the same manner as that of Example 17, with the exception that the used components and contents were changed to those shown in Table 3 below.

### Example 18

45 Parts by mass of the phenylene ether resin (i) obtained in accordance with Synthetic Example 1, 20 parts by mass of the petroleum resin (PETROTAC 90V, manufactured by TOSOH CORPORATION), 20 parts by mass of the bismaleimide compound (BMI-70, K.I Chemical Industry Co., LTD.) used as a crosslinking agent, and 15 parts by mass of divinylbenzene (DVB-630, NIPPON STEEL Chemical & Material Co., Ltd.) were placed in an eggplant flask, and toluene and methyl ethyl ketone were then added thereto, so that these components were completely dissolved in the solvents. Thereafter, the obtained solution was subjected to vacuum concentration to obtain a resin composition as a mixture of the 4 components. The evaluation results of the obtained resin composition are shown in Table 3 below. The resin composition of Comparative Example 10 was obtained in the same manner as that of Example 18, with the exception that the used components and contents were changed to those shown in Table 3 below.

### <Calculation of Percentage of Number of Polymerizable Double Bonding Groups (A) and Number of Hydroxyl Groups (B) in Phenylene Ether Resin>

In the phenylene ether resin represented by the general formula (1), Z₁ and Z₂, which may be the same or different, each represent a hydrogen atom or a unit comprising a polymerizable double bonding group. Accordingly, the present phenylene ether resin means to have a polymerizable double bonding group and/or a hydroxyl group in a molecular structure thereof.

The percentage of the number of the polymerizable double bonding groups (A) [eq./g] per unit weight and the number of hydroxyl groups (B) [eq./g] per unit weight is obtained by obtaining each of the double bond equivalent [g/eq.] and the hydroxyl group equivalent [g/eq.] from the measurement results obtained using an infrared spectrometer, and calculating the percentage from the reciprocals.

First, the double bond equivalent [g/eq.] was obtained as follows.

Powders of the phenylene ether resin were weighed, and the weight was recorded. These powders were placed in a volumetric flask, and carbon disulfide was then added up to a predetermined amount to prepare a measurement sample. This sample solution was placed in a measuring cell and was set in an infrared spectrophotometer (FT/IR-4600, manufactured by JASCO Corporation).

Subsequently, the sample solution was subjected to infrared spectroscopy. In the case of a phenylene ether resin whose polymerizable double bonding groups are styryl groups, as shown in the above Synthetic Example 1, the peak area of the spectrum around 905 cm⁻¹ was recorded. In the case of a phenylene ether resin whose polymerizable double bonding groups are methacryl groups, as shown in the above Example 15, the peak area of the spectrum around 1640 cm-1 was recorded. From this area value and the calibration curve, the double bond concentration [mol/L] was obtained as a measured value.

Subsequently, the double bond equivalent was calculated according to the following equation:

Double bond equivalent [g/eq.]=weight [g] of powders in measurement sample/double bond concentration [mol/L]×amount of measurement sample solution [L].

The hydroxyl group equivalent [g/eq.] was obtained as follows.

Powders of the phenylene ether resin were weighed, and the weight was recorded. These powders were placed in a volumetric flask, and dichloromethane was then added up to a predetermined amount to prepare a measurement sample. This sample solution was placed in a measuring cell and was set in an infrared spectrophotometer (FT/IR-4600, manufactured by JASCO Corporation).

The sample solution was subjected to infrared spectroscopy, and the peak area of the spectrum around 3600 cm⁻¹ was recorded. From this area value and the calibration curve, the hydroxyl group concentration [mol/L] was obtained as a measured value.

Subsequently, the hydroxyl group equivalent was calculated according to the following equation:

Hydroxyl group equivalent [g/eq.]=weight [g] of powders in measurement sample/hydroxyl group concentration [mol/L]×amount of measurement sample solution [L].

The thus calculated double bond equivalent and hydroxyl group equivalent were both converted to reciprocal values, so that the number of the double bonding groups (A) per unit weight and the number of hydroxyl groups (B) per unit weight were each obtained:

$$Number of double bonds [ eq . / g ] = 1 / double bond equivalent [ g / eq . ] , and \qquad ( A )$$

$$Number of hydroxyl groups [ eq . / g ] = 1 / hydroxyl group equivalent [ g / eq . ] . \qquad ( B )$$

When the above-obtained values (A) and (B) are indicated with percentages [%], (A) and (B) satisfies the following relational expression in the present invention:

$$( A ) / ( B ) = 95. to 99.5 / 0.5 to 5. .$$

The value of the percentage of the number of hydroxyl groups (B) is shown in Tables 1 and 2 below.

### <Measurement of Minimum Melt Viscosity>

With regard to the powders of the resin compositions obtained in individual examples and comparative examples, after confirming according to GC measurement (GC-14B, manufactured by Shimadzu Corporation) that the amount of the remaining solvent was 1% or less, 1 g of the powders were weighed and were then molded into a tablet with a diameter of 25 mm, so as to produce a measurement sample. Thereafter, the minimum melt viscosity (Pa·s) was obtained by measuring it at a temperature-increasing rate of 5° C./min and a frequency of 10 rad/s, using a viscoelasticity measuring device (DHR-2, manufactured by TA Instruments Japan Inc.). The measurement results are shown in Tables 1 and 2 below.

### <Measurement of Dielectric Dissipation Factor>

A cured product was produced as follows, using the powders of the resin compositions obtained in individual examples and comparative examples. In the frame of a 100 mm×30 mm stainless steel mold, 4.5 g of resin composition powders were fully placed. The mold was set into a vacuum pressing machine (manufactured by Oji Machine Co., Ltd.), and was retained at 200° C. for 1.5 hours and was pressed at a surface pressure of 1.9 MPa.

The dielectric dissipation factor (Df) of the thus obtained cured product was measured at 10 GHz, using a perturbation method cavity resonator (Agilent 8722ES, manufactured by Agilent Technologies Japan, Ltd.). The measurement temperature was set to be 23° C. The measurement results are shown in Tables 1 and 2 below.

<Measurement of glass transition temperature (Tg)>

The glass transition temperature (Tg) of the obtained cured product was measured by a DMA (Dynamic Mechanical Analysis) bending method using a dynamic viscoelasticity analyzer (DMA Q800, manufactured by TA Instruments Japan Inc. Inc.) in accordance with JIS C6481 5.17.2, and it was used as a peak temperature of the obtained loss modulus. The measurement results are shown in Tables 1 and 2 below.

### <Measurement of Peel Strength>

The resin compositions obtained in individual examples and comparative examples were each dissolved in toluene, so as to obtain a varnish having a desired solid concentration. Besides, the additive amount of each component is indicated as an amount obtained by removing the solvent from the amount of each component (i.e. the amount of a solid). This varnish was impregnated into an NE-glass woven fabric with a thickness of 0.08 mm, was then dried by heating at 150° C. for 7 minutes, so as to obtain a prepreg comprising 50% by mass of the resin.

The above-obtained two prepregs were stacked on each other, and electrolytic copper foils (HS-VSP, manufactured by MITSUI MINING & SMELTING CO., LTD.) with a thickness of 18 μm were placed on the top and bottom of the resulting prepreg. The resulting prepreg was retained at 200° C. for 1.5 hours, and was subjected to lamination molding at a surface pressure of 1.9 MPa, so as to obtain a metallic foil-clad laminated plate with a thickness of 0.2 mm. Using the obtained metallic foil-clad laminated plate, the peel strength (peeling strength) of the copper foil was measured in accordance with JISC6481. The measurement results are shown in the following Table 2.

TABLE 1

| | | | Comp. | Comp. | Comp. | | | |
|---|---|---|---|---|---|---|---|---|
| | | | Ex. 1 | Ex. 2 | Ex. 3 | Ex. 1 | Ex. 2 | Ex. 3 |
| Phenylene ether resin | | Phenylene ether resin (i) | — | — | 100 | 80 | 80 | 80 |
| | | Phenylene ether resin (ii) | — | — | — | — | — | — |
| | | Phenylene ether resin (iii) | 100 | 80 | — | — | — | — |
| | | SA9000 | — | — | — | — | — | — |
| Petroleum | C5, C9-based | PETROTAC 90V | — | 20 | — | 20 | — | — |
| resin | C9-based | PETCOAL 130 | — | — | — | — | 20 | — |
| | Dicyclopentadiene-based | HA125 | — | — | — | — | — | 20 |

| Percentage [%] of number of hydroxyl groups (B) | | 10.0 | 10.0 | 2.0 | 2.0 | 2.0 | 2.0 |
|---|---|---|---|---|---|---|---|
| in general formula (1) | | | | | | | |
| Evaluation item | Df (10 GHz) | 0.0082 | 0.0074 | 0.0019 | 0.0020 | 0.0019 | 0.0018 |
| | Tg [° C.] | 155 | 161 | 216 | 182 | 189 | 194 |
| | Minimum melt viscosity [Pa · s] | 110 | 40 | 580 | 210 | 200 | 120 |

| | | | Comp. | | | | Comp. | |
|---|---|---|---|---|---|---|---|---|
| | | | Ex. 4 | Ex. 4 | Ex. 5 | Ex. 6 | Ex. 5 | Ex. 7 |
| Phenylene ether resin | | Phenylene ether resin (i) | — | — | — | — | — | — |
| | | Phenylene ether resin (ii) | 100 | 80 | 80 | 80 | — | — |
| | | Phenylene ether resin (iii) | — | — | — | — | — | — |
| | | SA9000 | — | — | — | — | 100 | 80 |
| Petroleum | C5, C9-based | PETROTAC 90V | — | 20 | — | — | — | 20 |
| resin | C9-based | PETCOAL 130 | — | — | 20 | — | — | — |
| | Dicyclopentadiene-based | HA125 | — | — | — | 20 | — | — |

| Percentage [%] of number of hydroxyl groups (B) | | 3.2 | 3.2 | 3.2 | 3.2 | 1.1 | 1.1 |
|---|---|---|---|---|---|---|---|
| in general formula (1) | | | | | | | |
| Evaluation item | Df (10 GHz) | 0.0024 | 0.0026 | 0.0024 | 0.0022 | 0.0043 | 0.0036 |
| | Tg [° C.] | 236 | 207 | 205 | 214 | 205 | 198 |
| | Minimum melt viscosity [Pa · s] | 120 | 110 | 100 | 90 | 3,400 | 1,220 |

TABLE 2

| | | | | Comp. | | | | Comp. | |
|---|---|---|---|---|---|---|---|---|---|
| | | | Ex. 1 | Ex. 6 | Ex. 8 | Ex. 9 | Ex. 10 | Ex. 7 | Ex. 11 |
| Phenylene | | Phenylene ether | 80 | 70 | 60 | 50 | 60 | — | — |
| ether resin | | resin (i) | | | | | | | |
| | | Phenylene ether | — | — | — | — | — | 80 | 70 |
| | | resin (ii) | | | | | | | |
| | | SA9000 | — | — | — | — | — | — | — |
| Petroleum | C5, C9-based | PETROTAC 90V | 20 | — | 10 | 20 | 10 | — | — |
| resin | C9-based | PETCOAL 130 | — | — | — | — | — | — | 10 |
| | Dicyclopentadiene-based | HA125 | — | — | — | — | — | — | — |

| Thermoplastic elastomer | SEPTON 4033 | — | — | 30 | 30 | — | 20 | 20 |
|---|---|---|---|---|---|---|---|---|
| | HYBRAR 7311F | — | — | — | — | 30 | — | — |
| Percentage [%] | | 2.0 | 2.0 | 2.0 | 2.0 | 2.0 | 3.2 | 3.2 |
| of number of hydroxyl | | | | | | | | |
| groups (B) | | | | | | | | |
| in general formula (1) | | | | | | | | |
| Evaluation item | Df (10 GHz) | 0.0020 | 0.0016 | 0.0015 | 0.0016 | 0.0017 | 0.0023 | 0.0022 |
| | Tg [° C.] | 182 | 226 | 212 | 198 | 210 | 247 | 232 |
| | Minimum melt | 210 | 2,890 | 2,380 | 1,900 | 2,570 | 600 | 510 |
| | viscosity [Pa · s] | | | | | | | |
| | Peel strength | 0.41 | 0.80 | 0.79 | 0.76 | 0.81 | 0.75 | 0.71 |
| | [kg/cm] | | | | | | | |

| | | | | | Comp. | | | |
|---|---|---|---|---|---|---|---|---|
| | | | Ex. 12 | Ex. 13 | Ex. 8 | Ex. 14 | Ex. 15 | Ex. 16 |
| Phenylene | | Phenylene ether | — | — | — | — | — | — |
| ether resin | | resin (i) | | | | | | |
| | | Phenylene ether | 70 | 70 | — | — | — | — |
| | | resin (ii) | | | | | | |
| | | SA9000 | — | — | 80 | 70 | 60 | 60 |
| Petroleum | C5, C9-based | PETROTAC 90V | — | — | — | — | — | — |
| resin | C9-based | PETCOAL 130 | 20 | 10 | — | — | — | — |
| | Dicyclopentadiene-based | HA125 | — | — | — | 10 | 20 | 20 |

| Thermoplastic elastomer | SEPTON 4033 | 10 | — | 20 | 20 | 20 | — |
|---|---|---|---|---|---|---|---|
| | HYBRAR 7311F | — | 20 | — | — | — | 20 |
| Percentage [%] | | 3.2 | 3.2 | 1.1 | 1.1 | 1.1 | 1.1 |
| of number of hydroxyl | | | | | | | |
| groups (B) | | | | | | | |
| in general formula (1) | | | | | | | |
| Evaluation item | Df (10 GHz) | 0.0024 | 0.0026 | 0.0031 | 0.0030 | 0.0031 | 0.0033 |

| | | | | | | |
|---|---|---|---|---|---|---|
| Tg [° C.] | 221 | 233 | 236 | 231 | 224 | 226 |
| Minimum melt | 470 | 550 | 3,120 | 2,840 | 2,510 | 2,710 |
| viscosity [Pa · s] | | | | | | |
| Peel strength | 0.73 | 0.73 | 0.50 | 0.49 | 0.52 | 0.54 |
| [kg/cm] | | | | | | |

PETCOAL 130 is a petroleum resin manufactured by TOSOH CORPORATION, whereas HYBRAR7311F is a thermoplastic elastomer manufactured by KURARAY CO., LTD.

TABLE 3

| | | | Comp. Ex. 9 | Comp. Ex. 10 | Ex. 17 | Ex. 18 |
|---|---|---|---|---|---|---|
| Phenylene ether resin | | Phenylene ether resin (i) | 80 | 65 | 60 | 45 |
| Petroleum resin | C5, C9-based | PETROTAC 90V | | | 20 | 20 |
| Crosslinking | Bismaleimide | BMI-70 | 20 | 20 | 20 | 20 |
| agent | Vinyl compound | Divinylbenzene DVB-630 | | 15 | | 15 |

| Percentage of number of hydroxyl groups (B) in general formula (1) | | 2.0 | 2.0 | 2.0 | 2.0 |
|---|---|---|---|---|---|
| Evaluation item | Df (10 GHz) | 0.0020 | 0.0020 | 0.0019 | 0.0019 |
| | Tg [° C.] | 240 | 250 | 220 | 210 |
| | Minimum melt viscosity [Pa · s] | 2,500 | 210 | 310 | 50 |

1. A resin composition comprising a phenylene ether resin and a petroleum resin, wherein the phenylene ether resin is represented by the following general formula (1): 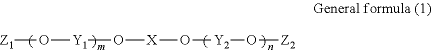
wherein X represents a unit comprising an aromatic ring; Y₁ and Y₂, which may be the same or different, each represent a phenylene group; Z₁ and Z₂, which may be the same or different, each represent a hydrogen atom or a unit comprising a polymerizable double bonding group; and
at least any one of m and n is not 0, and m and n represent an integer of 0 to 300, wherein
in the general formula (1), with regard to the percentage (%) of the number of the polymerizable double bonding groups (A) [eq./g] and the number of hydroxyl groups (B) [eq./g], (A)/(B)=95.0 to 99.5/0.5 to 5.0.

2. The resin composition according to claim 1, wherein the phenylene ether resin represented by the general formula (1) is a resin represented by the following general formula (2): 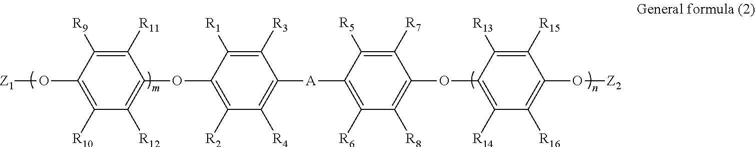
wherein A represents a single bond, or a linear, branched or cyclic hydrocarbon containing 10 or less carbon atoms; R₁ to R₁₆, which may be the same or different, each represent a hydrogen atom, a halogen atom, a linear or branched alkyl group containing 6 or less carbon atoms, or a phenyl group; at least any one of m and n is not 0, and m and n represent an integer of 0 to 300; and Z₁ and Z₂, which may be the same or different, each represent a hydrogen atom, or a substituent represented by the following general formula (3) or the following general formula (4): 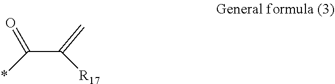
wherein R₁₇ represents a hydrogen atom or a methyl group; and * represents an atomic bonding. 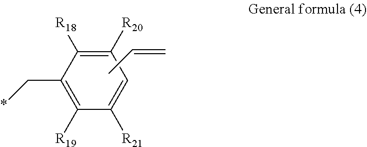
wherein R₁₈ to R₂₁, which may be the same or different, each represent a hydrogen atom, a halogen atom, a linear or branched alkyl group containing 6 or less carbon atoms, or a phenyl group; and * represents an atomic bonding.

3. The resin composition according to claim 2, wherein the resin represented by the general formula (2) is a resin represented by the following general formula (5): 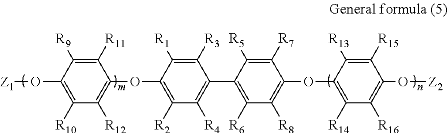
wherein R₁ to R₁₆, which may be the same or different, each represent a hydrogen atom, a halogen atom, a linear or branched alkyl group containing 6 or less carbon atoms, or a phenyl group; at least any one of m and n is not 0, and m and n represent an integer of 0 to 300; and Z₁ and Z₂, which may be the same or different, each represent a hydrogen atom, or the substituent represented by the general formula (3) or the general formula (4).

4. The resin composition according to claim 3, wherein, in the general formula (5), R₁, R₂, R₃, R₆, R₇, R₈, R₉, R₁₀, R₁₅, and R₁₆ each represent a methyl group, and R₄, R₅, R₁₁, R₁₂, R₁₃, and R₁₄ each represent a hydrogen atom.

5. The resin composition according to claim 1, wherein the number average molecular weight (Mn) of the phenylene ether resin represented by the general formula (1) is 800 to 3000, and the weight average molecular weight (Mw) thereof is 800 to 6000.

6. The resin composition according to claim 1, wherein, with regard to the mass ratio between the phenylene ether resin and the petroleum resin, the phenylene ether resin/the petroleum resin=90/10 to 50/50.

7. The resin composition according to claim 1, wherein the softening point of the petroleum resin is 80° C. or higher.

8. The resin composition according to claim 1, which further comprises a crosslinking agent.

9. The resin composition according to claim 8, wherein the crosslinking agent is bismaleimide.

10. The resin composition according to claim 8, wherein, with regard to the mass ratio among the phenylene ether resin, the petroleum resin and the crosslinking agent, the phenylene ether resin/(the petroleum resin+the crosslinking agent)=90/10 to 30/70.

11. The resin composition according to claim 1, which further comprises a thermoplastic elastomer.

12. The resin composition according to claim 11, wherein the thermoplastic elastomer is a styrene-based thermoplastic elastomer.

13. The resin composition according to claim 12, wherein the styrene-based thermoplastic elastomer comprises 10% to 50% by mass of a polystyrene site.

14. The resin composition according to claim 11, wherein, with regard to the mass ratio among the phenylene ether resin, the petroleum resin, the crosslinking agent and the thermoplastic elastomer, the phenylene ether resin/(the petroleum resin+the crosslinking agent+the thermoplastic elastomer)=90/10 to 30/70.

15. A curable film comprising the resin composition according to claim 1.

16. A laminated plate comprising the resin composition according to claim 1.
